(19) United States
(12) Patent Application Publication
(10) Pub. No.: US 2021/0089901 A1
(43) Pub. Date: Mar. 25, 2021

(54) METHOD AND APPARATUS FOR PROCESSING SENSOR DATA USING A CONVOLUTIONAL NEURAL NETWORK

(71) Applicant: Robert Bosch GmbH, Stuttgart (DE)

(72) Inventors: Arnold Smeulders, Amsterdam (NL); Ivan Sosnovik, Amsterdam (NL); Konrad Groh, Stuttgart (DE); Michal Szmaja, Amsterdam (NL)

(21) Appl. No.: 17/022,895

(22) Filed: Sep. 16, 2020

(30) Foreign Application Priority Data
Sep. 20, 2019 (DE) 102019214402.0

(51) Int. Cl. G06N 3/08; G06N 3/04

(52) U.S. Cl. CPC G06N 3/08; G06N 3/04

(57) ABSTRACT

A computer-implemented method for processing sensor data using a convolutional network. The method includes: processing the sensor data using several successive layers of the convolutional network, which has a convolution filter layer that receives an input matrix having input data values, implements a first filter matrix that is defined by a sum, weighted with a first weighting, of basic filter functions, calculates a second weighting from the first weighting by applying to the first weighting, for a respective value of a transformation parameter, a transformation formula that is parameterized by the transformation parameter, for each second weighting, ascertains a respective second filter matrix by calculating a sum, weighted with the second weighting, of the basic filter functions, and convolutes the input matrix with the first filter matrix and with each of the second filter matrices, so that for each filter matrix, an output matrix having output data values is generated.

### CROSS REFERENCE

The present application claims the benefit under 35 U.S.C. § 119 of German Patent Application No. DE 102019214402.0 filed on Sep. 20, 2019, which is expressly incorporated herein by reference in its entirety.

### FIELD

Various exemplifying embodiments of the present invention relate in general to an apparatus and a method for processing sensor data using a convolutional neural network.

### BACKGROUND INFORMATION

Neural networks have a broad application spectrum at present and are used, for instance, to recognize objects in image data or to control robots and self-driving vehicles. Thanks to their plurality of parameters, they can process very complex data sets and are trained with the objective of arriving at good predictions for subsequent unknown input data, for instance classifying as correctly as possible the objects in an image. A particularly successful neural network for such applications is a convolutional neural network (CNN).

Very recent progress in machine learning and machine vision has shown that a model (such as a neural network) can benefit from the inclusion of prior knowledge. One possibility for such prior knowledge is the assumption that a specific transformation does not modify the model's prediction. In accordance with that prior knowledge, it is possible to use a model that, by design, is equivariant or invariant with respect to that transformation.

According to an exemplifying embodiment (exemplifying embodiment 1) of the present invention, a computer-implemented method for processing sensor data using a convolutional network is furnished, encompassing: processing the sensor data using several successive layers of the convolutional network, the convolutional network having a convolution filter layer that receives at least one input matrix having input data values; implements a first filter matrix that is defined by a sum, weighted with a first weighting, of basic filter functions; calculates at least a second weighting from the first weighting by applying to the first weighting, for a respective value of a transformation parameter, a transformation formula that is parameterized by the transformation parameter; for each second weighting, ascertains a respective second filter matrix by calculating a sum, weighted with the second weighting, of the basic filter functions; and convolutes the input matrix with the first filter matrix and with each of the second filter matrices, so that for each filter matrix, an output matrix having output data values is generated; and having an aggregation layer that combines the output matrices.

The method makes it possible for a convolutional network to be trained and to operate equivariantly or invariantly with respect to parametric transformations, the transformations being capable of being estimated from a given training data set. This makes it possible to avoid overfitting and to reduce the data volume necessary for training, since it is not necessary for all variants to be contained in the training data.

Exemplifying embodiment 2 of the present invention is a method in accordance with exemplifying embodiment 1, the transformation parameter being an angle, and the convolution filter layer calculating the second weighting by applying the transformation formula in such a way that the second filter matrix is the first filter matrix rotated through the angle.

This makes it possible for the convolutional network to be invariant or equivariant with respect to rotations, for example of objects to be classified.

Exemplifying embodiment 3 in accordance with the present invention is a method in accordance with exemplifying embodiment 1, the transformation parameter being a scaling parameter, and the convolution filter layer calculating the second weighting by applying the transformation formula in such a way that the second filter matrix is a scaling of the first filter matrix, the intensity of the scaling being defined by the scaling parameter.

This makes it possible for the convolutional network to be invariant or equivariant with respect to changes in size, for example of objects to be classified, which occur e.g. because of the distance of an object.

Exemplifying embodiment 4 of the present invention is a method in accordance with one of exemplifying embodiments 1 to 3, the aggregation layer ascertaining for each output matrix a respective value of a predefined evaluation variable, and combining the output matrices by the fact that it outputs the identification of the output matrix for which the evaluation variable is maximal.

The result is that the network recognizes the transformation parameter (e.g., the rotation angle) for which a convolution filter best corresponds to the input matrix of the convolution filter layer. For example, the convolution network recognizes the orientation or the distance at which an object is present in an image. Layers that follow the convolution filter layer could use that information for a regression or classification.

Exemplifying embodiment 5 of the present invention is a method in accordance with one of exemplifying embodiments 1 to 4, encompassing training of the convolutional network by comparing values predicted for training data by the convolution network with reference values predefined for the training data, coefficients of the first weighting and/or coefficients of the transformation formula being trained.

Training of the weighting and/or of the coefficients makes it possible for the convolutional network to be adapted to the transformations that can occur in the sensor data.

Exemplifying embodiment 6 of the present invention is a method in accordance with one of exemplifying embodiments 1 to 5, encompassing controlling an actuator based on an output of the convolutional network.

Exemplifying embodiment 7 of the present invention is a convolutional network having several successive layers that encompass a convolution filter layer and an aggregation layer, the convolution network being configured to carry out a method in accordance with one of exemplifying embodiments 1 to 6.

Exemplifying embodiment 8 of the present invention is a software or hardware agent, in particular a robot, having a sensor that is configured to furnish sensor data and having a convolutional network in accordance with exemplifying embodiment 7, the convolutional network being configured to carry out a regression or classification of the sensor data.

Exemplifying embodiment 9 of the present invention is a software or hardware agent in accordance with exemplifying embodiment 8, having an actuator and a control device that is configured to control the at least one actuator using an output of the convolutional network.

Exemplifying embodiment 10 of the present invention is a computer program encompassing program instructions that are configured to carry out, when they are executed by one or several processors, the method according to one of exemplifying embodiments 1 to 6.

Exemplifying embodiment 11 of the present invention is a machine-readable storage medium on which are stored program instructions that are configured to carry out, when they are executed by one or several processors, the method according to one of exemplifying embodiments 1 to 6.

Exemplifying embodiments of the present invention are depicted in the Figures and are explained in further detail below. In the figures, identical reference characters generally refer to the same parts in all the various views. The figures are not necessarily to scale, the emphasis instead being placed in general on presenting the features of the present invention.

### BRIEF DESCRIPTION OF THE DRAWINGS

FIG. 1 shows an example of object recognition in the context of autonomous driving in accordance with the present invention.

FIG. 2 shows an example of a neural network in accordance with an example embodiment of the present invention.

FIG. 3 shows an example of a convolutional neural network in accordance with the present invention.

FIG. 4 illustrates the application of a convolution filter to two-dimensional input data in accordance with an example embodiment of the present invention.

FIG. 5 illustrates examples of filter functions in accordance with the present invention.

FIG. 6 illustrates examples of a rotation of a filter function for various rotation angles in accordance with the present invention.

FIG. 7 shows a flow chart that illustrates a method for processing sensor data using a convolutional network, in accordance with an example embodiment of the present invention.

### DETAILED DESCRIPTION OF EXAMPLE EMBODIMENTS

In machine learning, a function that maps input data onto output data is learned. During learning (for example, training of a neural network or of another model), the function is determined from an input data set (also called a “training data set”), which defines for each input a desired output (e.g., a desired classification of the input data), in such a way that it optimally maps that allocation of inputs to outputs.

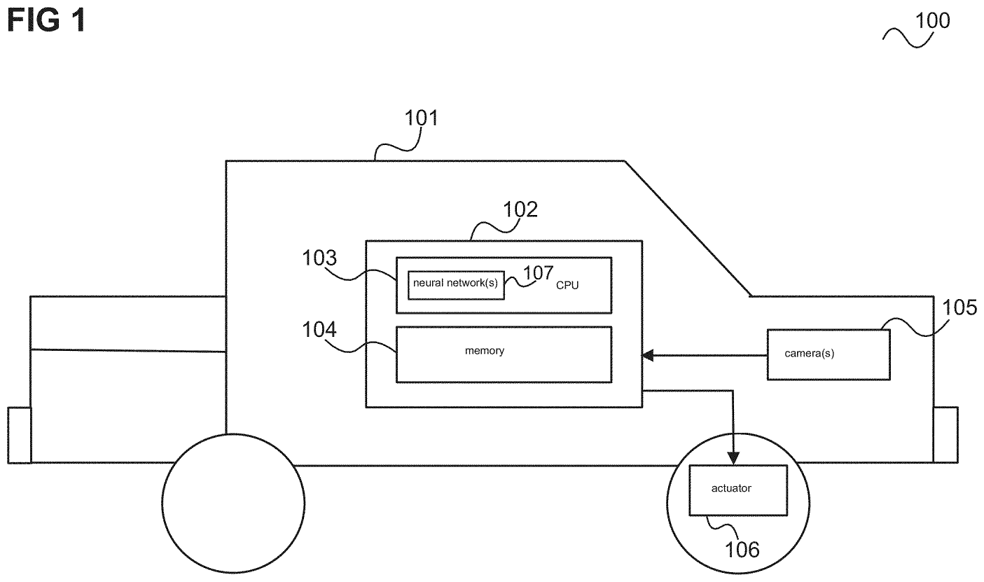

One example of an application of a machine-learned function of this kind is object classification for autonomous driving, as illustrated in FIG. 1.

Note that images or image data are construed hereinafter very generally as a collection of data that represent one or several objects or patterns. The image data can be furnished by sensors that measure visible or invisible light, e.g., infrared or ultraviolet light, ultrasonic or radar waves, or other electromagnetic or acoustic signals.

In the example of FIG. 1, a vehicle 101, for example a passenger car or commercial vehicle, is equipped with a vehicle control device 102.

Vehicle control device 102 has data processing components, for instance a processor (e.g., a CPU (central processing unit)) 103 and a memory 104 for storing control software according to which vehicle control device 102 operates, and data that are processed by processor 103.

The stored control software encompasses, for example, (computer program) instructions that, when the processor executes them, cause processor 103 to implement one or several neural networks 107.

The data stored in memory 104 can contain, for example, image data that are acquired by one or several cameras 105. The one or several cameras 105 can, for example, acquire one or several grayscale or color photos of the surroundings of vehicle 101.

Based on the image data, vehicle control device 102 can ascertain whether, and which, objects, for instance fixed objects such as road signs or road markings, or movable objects such as pedestrians, animals, and other vehicles, are present in the surroundings of vehicle 101.

Vehicle 101 can then be controlled by vehicle control device 102 in accordance with the results of the object determination. For example, vehicle control device 102 can control an actuator 106 (e.g., a brake) in order to control the speed of the vehicle, for instance in order to decelerate the vehicle.

According to an embodiment of the present invention, in the example of FIG. 1 control occurs on the basis of an image classification that is carried out by a neural network.

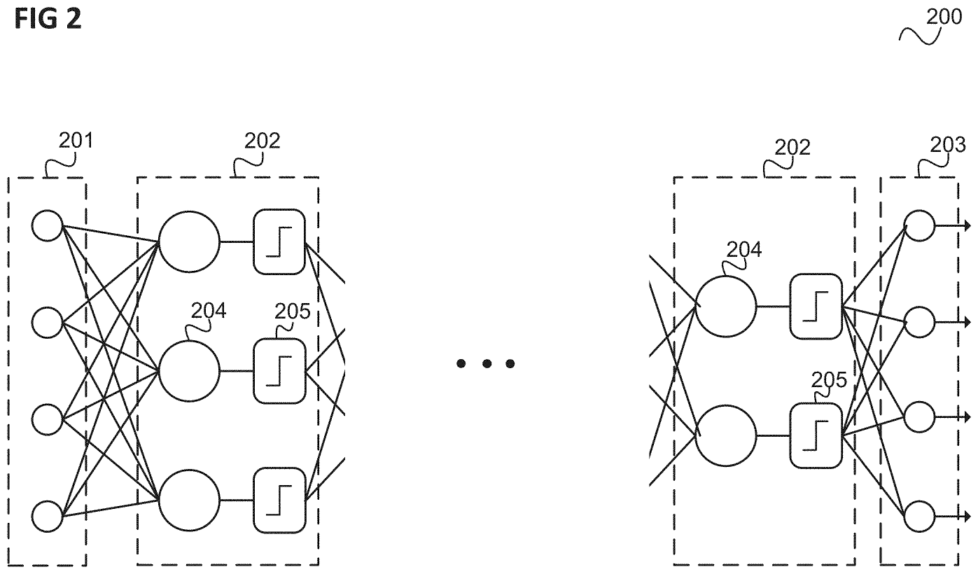

FIG. 2 shows an example of a neural network 200 that is configured to map input data onto output data; for example, the neural network can be configured to classify images into a predefined number of classes.

In this example, neural network 200 contains an input layer 201, several “hidden” layers 202, and an output layer 203.

Note that neural network 200 is a simplifying example of an actual neural network, which can contain many more processing nodes and hidden layers.

The input data correspond to input layer 201, and can be regarded in general as a multidimensional assemblage of values; for instance, an input image can be considered a two-dimensional assemblage of values that correspond to the pixel values of the image. The input of input layer 201 is connected to processing nodes 204.

If a layer 202 is a “fully connected” layer, a processing node 204 then multiplies each input value of the input data by a weight, and sums the calculated values. A node 204 can additionally add a bias to the sum. In a fully connected layer, processing nodes 204 are furthermore followed by a nonlinear activation function 205, e.g., a ReLU unit (ƒ(x)=max(0,x)) or a sigmoid function (ƒ(x)=1/(1+exp(−x))). The resulting value is then outputted to the next layer.

At least some of layers 202 can, however, also encompass not fully connected layers, e.g., convolution layers or pooling layers in the case of a convolutional neural network.

Output layer 203 receives values from the last layer 202 (of the sequence of layers 202). Typically, output layer 203 processes these received values and then outputs them for further processing. In the case in which the neural network serves for image classification, for instance, output layer 203 converts the received values into probabilities, those probabilities indicating that an image corresponds to one of the predefined classes. The class having the highest probability can then be outputted by output layer 203 as a predicted class for further processing. In order to train neural network 200, it is possible to ascertain, for training data having a known class allocation, whether the class predicted by neural network 200 matches the known class, or to evaluate the probability that the neural network has ascertained for the known class, typically using a loss function. The procedure can be similar when training neural network 200 for segmentation or regression, etc.

Note that classification of an image can be regarded as equivalent to classification of an object that is depicted in the image. If an original image encompasses several objects, as in the case of autonomous driving, a segmentation can be carried out (possibly by another neural network), so that each segment shows one object, and the segments are used as input for the image-classifying neural network.

Convolutional neural networks (CNNs) are a particular type of neural network that is particularly suitable for analyzing and classifying image data.

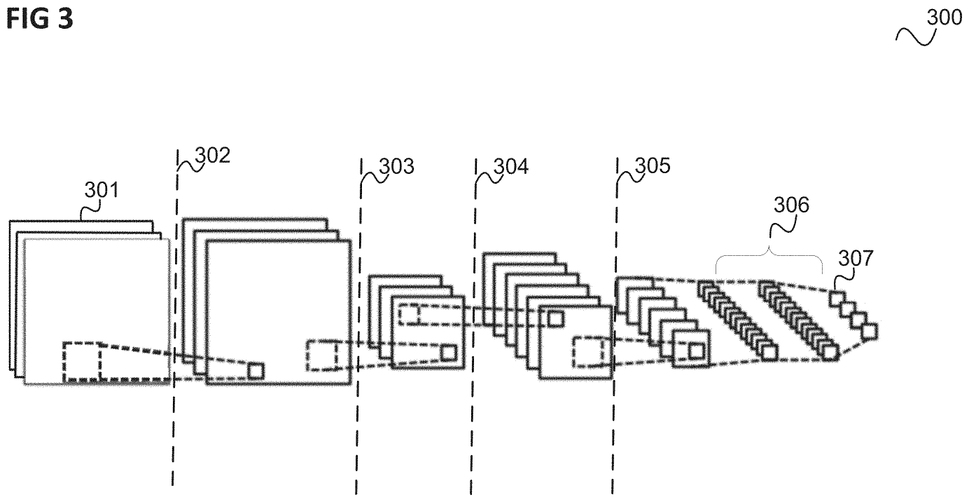

FIG. 3 shows an example of a convolutional neural network 300.

Note that in the depiction of FIG. 3, only the input data and output data of the various layers of neural network 300 are shown, and the layers are symbolized merely with dashed lines. The layers can have a form as described with reference to FIG. 2.

The input data correspond to an input layer 301. The input data are, for instance, RGB images that can be regarded as three two-dimensional matrices (that correspond to the pixel values of the image). The three matrices can also be regarded as a single three-dimensional array that is also called a “tensor.” A tensor can be regarded as an n-dimensional array, or can be understood as a generalization of a matrix; for instance, a number is a zero-dimensional tensor, a vector is a one-dimensional tensor, a matrix is a two-dimensional tensor, a cube made up of numbers is a three-dimensional tensor, a vector made up of cubes is a four-dimensional tensor, a matrix made up of cubes is a five-dimensional tensor, and so on.

Convolutional neural networks often use three- and four-dimensional tensors; for example, multiple RGB images can be construed as four-dimensional tensors (number of images×number of channels (e.g., three)×height×width).

The input data are processed by a first convolution layer 302. In a convolution layer, the input data are modified by convolution filters that can be regarded as a (two- or even three-dimensional) assemblage of values.

The convolution filters take a subset of the input data and apply a convolution to it. They can be interpreted in such a way that they represent possible features in the input data, e.g. a specific shape. The output of each convolution filter is a “feature map.”

A convolution filter is typically shifted “pixel-wise” over all the input data (of layer 202, to which the convolution filter pertains). For RGB images constituting input data, for example, the convolution filters correspond to three-dimensional tensors (or three filter matrices “on top of one another”) and are shifted over all the “pixels” (elements) of the images. It is also possible, however, to select different “strides” for the filters, for instance a stride of 2, i.e. only every second value is considered.

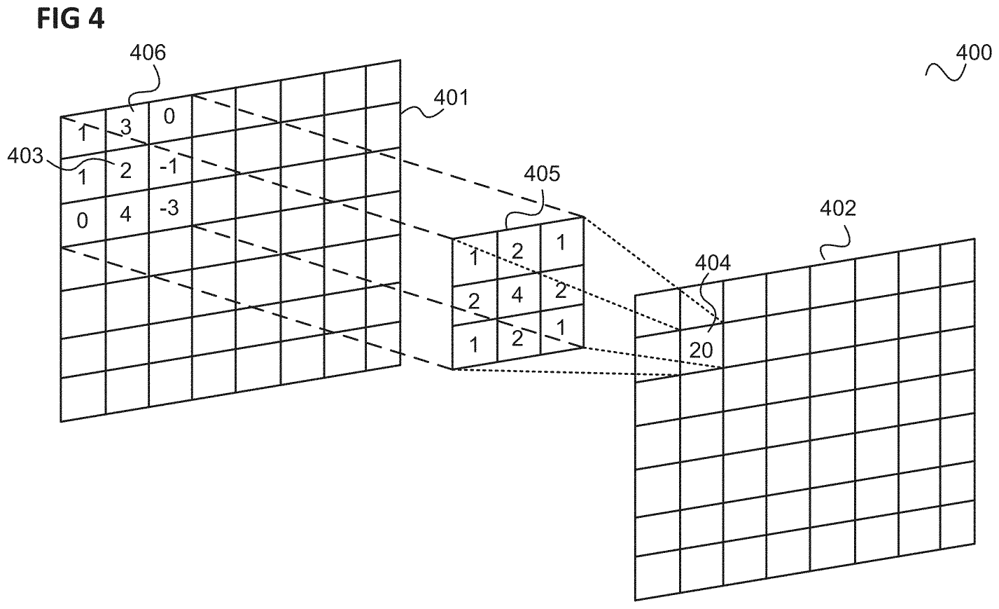

FIG. 4 illustrates the application of a convolution filter to two-dimensional input data 401.

Input data 401 of the filter are depicted as a two-dimensional matrix. Output data 402 of the filter are similarly depicted as a two-dimensional matrix. In a context of multiple channels (e.g. RGB images), several such matrices can lie “on top of one another” (and can constitute a tensor), but in the interest of simplicity only one channel is considered.

Output value 404 for an input value 403 is obtained by applying a filter matrix 405 to input value 403 and its surroundings 406 (depicted in FIG. 4 by the components of the matrix, other than input value 403, for which exemplifying entries are shown). The size of surroundings 406 is determined by filter matrix 405:

surroundings 406, together with input value 403, constitute a sub-matrix of the input data that is the same size as filter matrix 405. Filter matrix 405 is applied to input value 405 and its surroundings 406 by calculating the internal product of filter matrix 405 times the sub-matrix (both matrices construed as vectors). The result of the internal product is output value 404. For the exemplifying values shown in FIG. 4, the result is:

1*1+2*3+1*0+2*1+4*2+2*(−1)+1*0+2*4+(1*(−3)=20

For an image or a feature map constituting input data, each entry in the filter matrix can thus be understood as a weighting value for a pixel value in the sub-matrix of the input data. Each entry in the filter matrix thus corresponds to a pixel position (relative to the center of the filter matrix which is aligned on the current input value 405).

In the example, filter matrix 405 is a 3×3 matrix, but it can also have a different size. All the output values of output data 402 are clearly generated by shifting the filter matrix over input data 401, so that output data 402 ultimately correspond to the convolution of input data 401 with filter matrix 405.

At the edges of the input data, a value is not necessarily present in the input for all values of a filter, for instance at the edges of a matrix over which a 3×3 filter is being shifted.

One possibility for dealing with edges is to shift the filter only so long as it lies completely in the input, but this can decrease the output dimension (i.e., the dimension of the matrix to which the output data correspond) with respect to the input dimension (i.e., the dimension of the matrix to which the input data correspond). In the case of a 3×3 filter that is shifted over a matrix, for instance, the output dimension would decrease by 2×2 with respect to the input dimension.

There is another possibility for edge handling in order not to decrease the output dimension; this involves expanding the input data by “padding.” Usually the edges are filled in with zeroes (“zero padding”). For example, an input data matrix 401 is padded (i.e., bordered) on all four sides with zeroes so that the output of a 3×3 filter (that is shifted over the bordered matrix) has the same dimension as the original input matrix. It can also be padded in such a way that the dimension of the output is larger than the dimension of the input.

In convolution layer 302, the convolution filters are typically followed by a nonlinear activation function (not shown in FIG. 3), for instance a ReLU unit.

The data are then forwarded to a pooling layer 303. In pooling layer 303, a filter is once again shifted over the input data, that filter as a rule outputting the maximum or the average of several input values. In the example of FIG. 4, the average would then be taken over the values of the sub-matrix (having input value 403 in the center), or a maximum would be looked for, in order to generate output value 404. This filter typically has a stride greater than one, e.g., a stride of two or three. For instance, a 2×2 filter having a stride of two is shifted over an input data matrix, which yields a maximum of four input values in each case. In other words, the pooling layer combines (i.e., aggregates) several input values, so it is also referred to as an “aggregation layer.” The operation of the pooling layer can also be regarded as subsampling, and it can therefore also be referred to as a “subsampling layer.”

In other words, a pooling layer can be regarded as a form of nonlinear downsampling in which the volume of data is reduced by combining the outputs of several nodes in the next layer into a single node, for instance by accepting the maximum value of the outputs.

Typically there is no activation function in pooling layer 303, so that pooling can also be considered part of a convolution layer (or another layer) (each layer of a neural network usually has an activation function).

Pooling layer 303 is followed by a second convolution layer 304 that is in turn followed by a second pooling layer 305.

Note that a convolution layer can also be followed by a further convolution layer, and that many more convolution and/or pooling layers can be part of a convolutional neural network.

Whereas the input of first convolution layer 302 is, for example, a digital image, the input of a subsequent convolution layer 304 is a feature map that is outputted by a preceding convolution layer (or a preceding pooling layer 303).

Second pooling layer 305 is followed by one or several fully connected layers 306. Before that, the tensor obtained from second pooling layer 305 is flattened into a (one-dimensional) vector.

An output layer receives the data from the last fully connected layer 306, and outputs output data 307.

The output layer can contain a processing instance; for example values are converted into probabilities or probability vectors, for instance by applying the softmax function

$$( f ( x ) = \frac{exp ( {v}_{i} )}{{Σ}_{k = 1}^{K} exp ( {v}_{k} )} ,$$

where vᵢ (where i=1, . . . , K) are the received values) or the sigmoid function, and the class having the highest probability is then outputted for further processing.

Note that a convolutional neural network does not necessarily need to possess (or have at the end) a fully connected layer (or layers). It is furthermore also possible for a convolutional neural network to process several layers in parallel.

When training a neural network it can be desirable for the neural network to be trained in such a way that the function that it learns is invariant with respect to specific transformations. For example, it should always recognize a dog as a dog, even if it is at a different location in the digital image (translation); is smaller (scaling), for instance because it is farther away; or is contained in an oblique position in the image (rotation).

Approaches to training a neural network in such a way that it is invariant with respect to such transformations (e.g., so that it “learns invariants”) include impressing the invariants into the training data, into the network architecture, or into the loss function, for example by
supplementing the training data set by generating additional training data using a known transformation with respect to which the neural network is intended to be invariant, e.g. shifts, scaling, rotation, etc.;
introducing equivariant filters (e.g., with regard to a transformation such as rotation of the filter through 90, 180, 270 degrees), or using Gaussian filters;
impressing the invariance for a small transformation by adding terms to the loss function as in the tangent-prob method, in which a (local) invariance is achieved by adapting the loss function (or the gradient increment) during training.

Examples of configuration and training of a convolutional network, which result in the convolutional network being invariant or equivariant with respect to certain transformations of its input data, will be described below.

As explained with reference to FIG. 4, a filter of a convolutional network can be represented by a filter matrix 405. The group of real-valued invertible matrices will be referred to hereinafter as GL(n,R). Each completed subgroup of GL(n,R) is a (matrix) Lie group.

A volume of functions {ψᵢ}ᵢ₌₁^{N} defines a vector space V of functions by forming linear combinations of {ψᵢ}ᵢ₌₁^{N}. An element Lₐ of a Lie group, which is represented as a differential operator, operates on the volume of functions {ψᵢ}ᵢ₌₁^{N}. If the result of an application of Lₐ to a function ψᵢ is again in V, i.e. Lₐψᵢ is an element of V, the application of Lₐ can be construed as a matrix multiplication. In other words, the following control equation (also referred to hereinafter as a “transformation equation”) applies:

$${L}_{a} [ \begin{matrix}{ψ}_{1} \\ ⋯ \\ {ψ}_{N}\end{matrix} ] = B [ a ] [ \begin{matrix}{ψ}_{1} \\ ⋯ \\ {ψ}_{N}\end{matrix} ]$$

The matrix B[a] is also referred to as a “control matrix.” In the exemplifying embodiments described below, Lₐ represents a transformation of a convolution filter, and the parameter a that parameterizes the transformation can assume various parameter values.

A filter matrix 405 can be generated, from a filter kernel (or convolution kernel) κ, by the fact that for the pixel positions to which the entries of filter matrix 405 correspond, values are generated by inserting the pixel positions (e.g., as pixel coordinates x, y relative to the center of the filter matrix) into the convolution kernel (e.g., κ(x,y). The pixel positions can, however, also be scaled (which can be regarded, for instance, as a broadening or narrowing of the convolution kernel).

The transformation of a (spatial) convolution kernel by way of a Lie group can be described as a linear combination. For this, it is assumed that the convolution kernel κ can be described as a linear combination of basic functions ψᵢ. It is therefore an element of the vector space V=span{ψᵢ}:

κ=w₁ψ₁+ . . . +wₙψₙ=w^{T}ψ

If an element Lₐ of the Lie group is applied to the convolutional kernel κ, it follows that

Lₐ[κ]=Lₐ[w^{T}ψ]=w^{T}Lₐψ=w^{T}B[a]ψ

In other words, this means that as soon as a parameter value is selected for the parameter a of the Lie group (e.g., a rotation angle), the convolutional kernel can be correspondingly controlled (e.g. rotated) by the fact that the vector of the basic functions from which it is constituted by linear combination is multiplied using a matrix corresponding to the parameter.

As an example, a filter will be rotated, e.g., a convolutional kernel from which filter matrix 405 is constituted. In this case what is regarded as the Lie group is the special orthogonal group SO(3) and its Lie algebra so(3). This has only one (infinitesimal) generator that is defined by the differential operator

$$L = \frac{\partial }{\partial x} y - \frac{\partial }{\partial y} x .$$

As an example, it will be assumed that L operates on the vector space V of functions which is spanned by the volume of polynomials v₁=x², v₂=2xy, v₃=y². It is then the case that:

$${L}_{a} [ \begin{matrix}{x}^{2} \\ 2 x y \\ {y}^{2}\end{matrix} ] = \frac{\partial }{\partial x} y - \frac{\partial }{\partial y} x [ \begin{matrix}{x}^{2} \\ 2 x y \\ {y}^{2}\end{matrix} ] = [ \begin{matrix}0 & 1 & 0 \\ - 2 & 0 & 2 \\ 0 & - 1 & 0\end{matrix} ] [ \begin{matrix}{x}^{2} \\ 2 x y \\ {y}^{2}\end{matrix} ] \qquad ( 1 )$$

From this (from the exponential equation of the Lie group), the following equation can be derived:

$$B [ φ ] = exp \{ φ [ \begin{matrix}0 & 1 & 0 \\ - 2 & 0 & 2 \\ 0 & - 1 & 0\end{matrix} ] \} = \frac{cos 2φ}{2} [ \begin{matrix}1 & 0 & - 1 \\ 0 & 2 & 0 \\ - 1 & 0 & 1\end{matrix} ] + \frac{sin 2φ}{2} [ \begin{matrix}0 & 2 & 0 \\ - 1 & 0 & 1 \\ 0 & - 2 & 0\end{matrix} ] + \frac{1}{2} [ \begin{matrix}1 & 0 & 1 \\ 0 & 0 & 0 \\ 1 & 0 & 1\end{matrix} ] \qquad ( 2 )$$

where ϕ is the rotation angle and corresponds to the above parameter of the transformation a. In particular, according to the above:

L_{ϕ}[κ]=W^{T}B[ϕ](v₁,v₂,v₃)^{T} (3)

The matrix B[ϕ] therefore indicates how the vector of basic vectors (v₁,v₂,v₃)^{T} is to be transformed by ϕ upon rotation of the convolutional kernel (i.e. of the filter).

If a filter function ƒ: [symbol] ²→ [symbol] (i.e. a convolutional kernel) is selected from the function space V, the ultimate effect is to select a weight vector w∈ [symbol] ³ and to calculate the internal product:

ƒ(x,y,w)= [symbol] w,v [symbol] =w₁v₁+w₂v₂+w₃v₃=w₁x²+w₂xy+w₃y²

A filter matrix can therefore be generated by selecting a weighting w₁, w₂, w₃ and inserting discrete grid values (e.g., if applicable, scaled pixel positions relative to the center of the filter matrix) as x and y into the convolutional kernel.

For example, the result of setting x=−0.2, −0.1, 0, 0.1, 0.2, and y=−0.2, −0.1, 0, 0.1, 0.2 is to generate a 5×5 convolution matrix whose entries correspond to the 25 values of ƒ(x,y,w) for the 25 combinations of x and y.

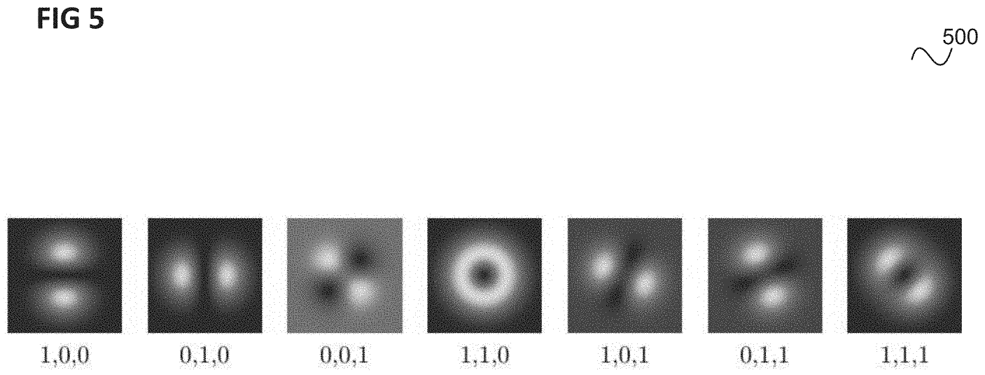

FIG. 5 shows examples of filter functions for combinations of w₁, w₂, w₃, the basic functions v1, v2, and v3 additionally being multiplied by exp(−2(x²+y²)).

A filter function of this kind can be rotated through the angle ϕ using equation (3) with B[ϕ] from equation (2). All that is needed for this is to calculate cos 2ϕ and sin 2ϕ, correspondingly multiply and sum the matrices in (2), and apply them to the basic function vector in accordance with (3).

This then yields new values for ƒ(x,y,w) as follows:

ƒ(x,y,w)= [symbol] w,v [symbol] =w₁v′₁+w₂v′₂+w₃v′₃

where (v₁,v₂,v₃)^{T}=B[ϕ](v₁,v₂,v₃)^{T}.

As a simple example, for (w₁,w₂,w₃)^{T}=(1,0,0), i.e. ƒ(x,y,w)=x², rotation through 45° yields:

$$B [ φ ] = \frac{1}{2} [ \begin{matrix}0 & 2 & 0 \\ - 1 & 0 & 1 \\ 0 & - 2 & 0\end{matrix} ] + \frac{1}{2} [ \begin{matrix}1 & 0 & 1 \\ 0 & 0 & 0 \\ 1 & 0 & 1\end{matrix} ]$$

and thus the rotated filter kernel ƒ(x,y,w)=(1,0,0)B[ϕ](v₁,v₂,v₃)^{T}=½(x²+2xy+y²)=½(x+^{y})².

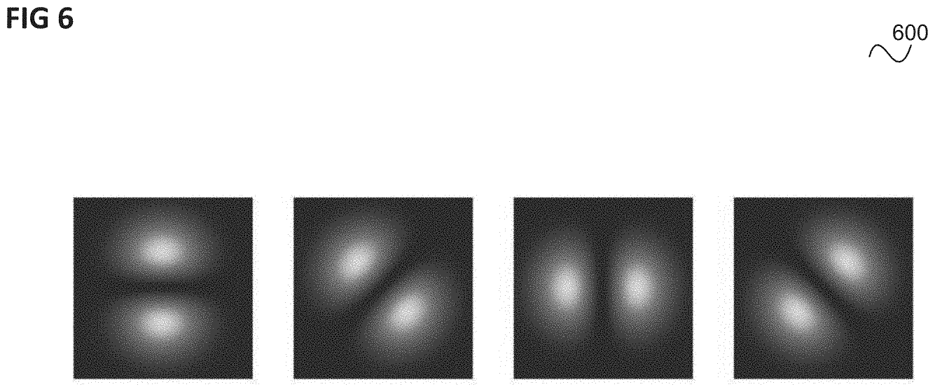

FIG. 6 shows the filter function for w₁=1, w₂=0, w₃=0 from left to right for the angles 0°, 45°, 90°, and 135°.

According to various embodiments of the present invention, a controllable and scalable convolution layer of a neural network is provided, for instance as a layer 202 of neural network 200.

A maximum degree is specified for the layer. A volume of functions is constituted by the homogeneous polynomial from degree 0 to the maximum degree. If the maximum degree is equal to three, for example, the functions are then defined as 1, x, y, x², xy, y², x³, x²y, xy², y³.

From these functions, basic functions v₁, . . . , v_{L} are then calculated by dividing each function by a power of a scaling parameter s, the exponent being equal to the degree of the respective function. For the example above, the basic functions that result are 1, x/s, y/s, x²/s², xy/s², y²/s², x³/s³, x²y/s³, xy²/s³, y³/s³.

A scaling and a grid size N are also selected. For each variable x, y, a corresponding centered grid is derived. For example, N=2 results in a spatial 5×5 (=(2N−1)×(2N−1)) filter (i.e. having a 5×5 filter matrix).

For N=2 and a scaling of 0.5, for example, the result is the centered grids

$$X = [ \begin{matrix}- 1 & - 1 & - 1 & - 1 & - 1 \\ - . 5 & - . 5 & - . 5 & - . 5 & - . 5 \\ 0 & 0 & 0 & 0 & 0 \\ .5 & .5 & .5 & .5 & .5 \\ 1 & 1 & 1 & 1 & 1\end{matrix} ] and Y = [ \begin{matrix}- 1 & - .5 & 0 & .5 & 1 \\ - 1 & - .5 & 0 & .5 & 1 \\ - 1 & - .5 & 0 & .5 & 1 \\ - 1 & - .5 & 0 & .5 & 1 \\ - 1 & - .5 & 0 & .5 & 1\end{matrix} ]$$

Each of the basic functions v₁, . . . , v₁, is evaluated at the points of the scaled grid produced by these matrices. This results in matrices V₁, . . . , V_{L}.

For example, the matrix produced for the basic function xy/s² with the above centered matrices, for x and y and the scaling parameter s=1, is

$$[ \begin{matrix}1 & 0.5 & 0 & - 0.5 & - 1 \\ 0.5 & - . 25 & 0 & - . 25 & - 0.5 \\ 0 & 0 & 0 & 0 & 0 \\ - 0.5 & - . 25 & 0 & 0.25 & 0.5 \\ - 1 & - 0.5 & 0 & 0.5 & 1\end{matrix} ]$$

The matrices are stacked, so that they yield an L×(2N+1)×(2N+1)-dimensional tensor V.

For the basic functions, a matrix K is derived which describes the operation of the differential operator Lₐ=L_{ϕ} on the volume of basic functions, analogously to the matrix on the right side of equation (1).

Using the matrix K, the control equation can be calculated analogously to (2).

Equation (2) is an example of the control equation for the basic functions x², 2xy, and y² (scaling parameter s=1), i.e. the homogeneous polynomial of degree 2. For the homogeneous polynomial of degree 3, the differential operator Lₐ operates on the volume of polynomials v₁=x³, v₂=x²y, v₃=xy², v₄=y³, as follows:

$${L}_{a} [ \begin{matrix}{x}^{3} \\ {x}^{2} y \\ x {y}^{2} \\ {y}^{3}\end{matrix} ] = \frac{\partial }{\partial x} y - \frac{\partial }{\partial y} x [ \begin{matrix}{x}^{3} \\ {x}^{2} y \\ x {y}^{2} \\ {y}^{3}\end{matrix} ] = [ \begin{matrix}0 & 3 & 0 & 0 \\ - 1 & 0 & 2 & 0 \\ 0 & - 2 & 0 & 1 \\ 0 & 0 & - 3 & 0\end{matrix} ] [ \begin{matrix}{x}^{3} \\ {x}^{2} y \\ x {y}^{2} \\ {y}^{3}\end{matrix} ]$$

From this, the following control equation can be derived:

$$exp \{ φ [ \begin{matrix}0 & 3 & 0 & 0 \\ - 1 & 0 & 2 & 0 \\ 0 & - 2 & 0 & 1 \\ 0 & 0 & - 3 & 0\end{matrix} ] \} = \frac{cos 3φ}{4} [ \begin{matrix}1 & 0 & - 3 & 0 \\ 0 & 3 & 0 & - 1 \\ - 1 & 0 & 3 & 0 \\ 0 & - 3 & 0 & 1\end{matrix} ] + \frac{sin 3φ}{4} [ \begin{matrix}0 & 3 & 0 & - 1 \\ - 1 & 0 & 3 & 0 \\ 0 & - 3 & 0 & 1 \\ 1 & 0 & - 3 & 0\end{matrix} ] + \\ \frac{cos φ}{4} [ \begin{matrix}3 & 0 & 3 & 0 \\ 0 & 1 & 0 & 1 \\ 1 & 0 & 1 & 0 \\ 0 & 3 & 0 & 3\end{matrix} ] + \frac{sin φ}{4} [ \begin{matrix}0 & 3 & 0 & 3 \\ - 1 & 0 & - 1 & 0 \\ 0 & 1 & 0 & 1 \\ - 3 & 0 & - 3 & 0\end{matrix} ] \qquad ( 4 )$$

In addition, a volume of trainable weight tensors Wₗ, . . . , W_{M} is defined for the layer.

Two exemplifying embodiments will be described below.

According to a first exemplifying embodiment, a discrete volume of angles and/or scalings is selected, for instance ϕ∈{0, 10, 20, . . . , 350}, s∈{1, 2, 3, 4, 5}.

For each angle and/or each scaling, each weight tensor Wₗ, . . . , W_{M} is multiplied by V along one or several axes. This is, for example, an internal product of the vector of weight matrices times the vector of basic function matrices. If the basic function matrices are tensors (higher dimension) then the weight matrices are also tensors, and the contraction (the internal product) is correspondingly adapted, i.e. several axes are contracted.

This yields a volume of convolutional kernels for the (controllable) layer.

The layer respectively convolutes its input data with each of the supplied convolutional kernels (as described with reference to FIG. 4). The results are pooled over the angle ϕ. This makes the layer invariant under ϕ and/or s.

The neural network is trained, for example, to carry out a classification or regression.

According to a second exemplifying embodiment, after training of the neural network for the task (e.g., classification or regression), all weights preceding the layer (i.e., for instance, all the weights with which inputs of the layer are weighted) are specified, and the input data are shifted using the layer. In addition, the argument (e.g., the angle) for which a maximum is assumed in the context of pooling is outputted by the layer. This output can be used as an input for a second network that has trainable weights and is being trained for a classification or regression. The argument can also be used in other ways. For example, the size of an object (represented by the value of a scaling parameter) can be used to estimate a distance of an object.

In the procedure above, the transformation group is defined (SO(2)), and from the space of the filter functions a filter can then be learned; the filter can be scale-invariant or rotation-invariant depending on how the filter layer will be further used. Because the transformation group is known, the control equation can be formulated directly (equation (2) for the space of filter functions that is spanned by v₁=x², v₂=2xy, v₃=y², and equation (3) for the space of filter functions that is spanned by the homogeneous polynomial of degree 3).

Exemplifying embodiments of the present invention in which the neural network learns the transformation group during training are described below. A transformation group adapted to the training data is therefore learned. In this case, however, the control equations are not known in advance. For example, a convolution layer 202 is provided which learns, during training, a control matrix as provided by equation (2). This makes it possible to impress equivariance or invariance into the neural network by selecting a general polynomial basis and a general set of parameters in the matrix equation, and the angle ϕ is learned and/or the convolution kernels for a set of angles (common weights being used) are rotated, and a pooling (e.g. by maximization) is carried out (for instance by disposing, subsequently to the convolution filter layer, a pooling layer that selects, by maximization, the respective value for an angle).

For this, as in the above exemplifying embodiment, filter matrices V₁, . . . , V_{L} pertinent to the basic functions are determined and stacked into a tensor V, and trainable weight tensors Wₗ, . . . , W_{M} are defined. In addition, a set of trainable tensors C₁, . . . , Cₖ of size L×L is defined.

In a first exemplifying embodiment of the present invention, a discrete volume of angles is selected, e.g. ϕ∈{0, 10, 20, . . . , 350}.

For the set of trainable tensors C₁, . . . , Cₖ, the following tensor is calculated for each of the selected angles ϕᵢ:

$$X ( {φ}_{i} ) {\sum }_{n = 1}^{\frac{( k - 1 )}{2}} ( cos ( n {φ}_{i} ) {C}_{2 n + 1} + sin ( n {φ}_{i} ) {C}_{2 n} ) + {C}_{1} ,$$

(for odd k; for even k a term can correspondingly be omitted), i.e. for instance in the case in which k=9:

X(ϕᵢ)=cos(4ϕᵢ)C₉+sin(4ϕᵢ)C₈+cos(3ϕᵢ)C₇+sin(3ϕᵢ)C₆+cos(2ϕᵢ)C₅+sin(2ϕᵢ)C₄+cos(ϕᵢ)C₃+sin(ϕᵢ)C₂+

For each angle, each weight tensor Wₗ, . . . , W_{M} is multiplied by V along one or several axes. This yields a volume of convolution kernels for the (controllable) layer.

The layer respectively convolutes its input data with each of the supplied convolutional kernels (as described with reference to FIG. 4). The results are pooled over the angle ϕᵢ. This makes the layer invariant under ϕ.

According to a second exemplifying embodiment, a second trainable function (e.g., a second neural network) is provided, to which the input data are delivered and which outputs ϕ at the convolution layer.

For the set of trainable tensors C₁, . . . , Cₖ, the following tensor is calculated for the angle ϕ (example for k=9; for smaller or larger k correspondingly; see also the formulas above):

X(ϕ)=cos(4ϕ)C₉+sin(4ϕ)C₈+cos(3ϕ)C₇+sin(3ϕ)C₆+cos(2ϕ)C₅+sin(2ϕ)C₄+cos(ϕ)C₃+sin(ϕ)C₂+C₁

For each angle, each weight tensor Wₗ, . . . , W_{M} is multiplied by V along one or several axes. This yields a volume of convolution kernels for the (controllable) layer.

Instead of pooling (e.g., max pooling, summing, sorting, etc.) in order to create invariance, an equivariant layer (or an equivariant network) is created by the fact that the parameter (e.g. the angle, in the example above) whose pertinent convolution kernel from among the convolution kernels generates the maximum output value, is outputted.

The neural network is trained for classification or regression.

In example embodiments of the present invention in which a neural network is trained for classification or regression, the input data are, for example, volumes of data points, for example an image or an audio signal, and for training the input data can be equipped with an identifier, e.g. a class or an output parameter. A training data set can contain a plurality of such input data volumes.

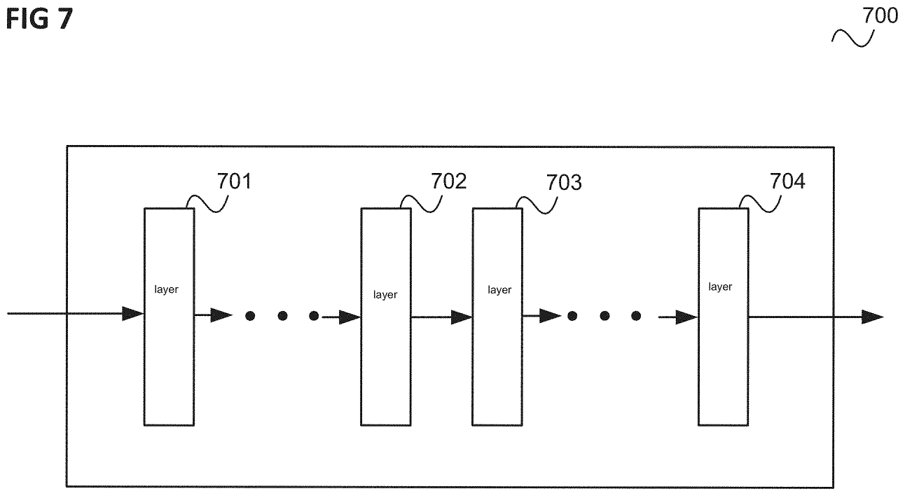

In summary, in accordance with a variety of exemplifying embodiments of the present invention, a method as depicted in FIG. 7 is furnished.

FIG. 7 shows a diagram 700 that illustrates a method for processing sensor data using a convolutional network.

The sensor data are processed by several successive layers 701 to 704 of the convolutional network, the convolutional network having a convolution filter layer 702 that
receives at least one input matrix having input data values;
implements (and, for instance, ascertains) a first filter matrix that is defined by a sum, weighted with a first weighting, of basic filter functions;
calculates at least one second weighting from the first weighting by applying to the first weighting, for a respective value of a transformation parameter, a transformation formula that is parameterized by the transformation parameter;
for each second weighting, ascertaining a respective second filter matrix by calculating a sum, weighted with the second weighting, of the basic filter functions; and
convoluting the input matrix with the first filter matrix and with each of the second filter matrices, so that an output matrix having output data values is generated for each filter matrix.

The convolution network furthermore has an aggregation layer 703 that combines the output matrices.

In other words, in accordance with various exemplifying embodiments of the present invention, a convolution layer that applies a parameterized filter for several parameter values is used in a convolutional network. The output data can then be pooled over the parameter values. An assemblage of a convolution layer and subsequent pooling layer is thus invariant under a modification of the parameter (typically, better so the more different parameter values that are used).

The convolutional network can be made invariant “by design” with respect to the transformation. It thus also becomes invariant with respect to a corresponding transformation (modification) of the training data (e.g., scaling and rotation). This in turn allows the convolutional network to be trained with a smaller volume of training data, since there is no risk that the convolutional network will be “overfitted” to specific transformation parameter values (e.g., to a specific orientation or scaling of an object); in other words, overfitting in terms of specific transformation parameter values is avoided. In a classification network, for example, the convolutional network is prevented from recognizing an object (e.g., an automobile) from the fact that it always occurs in a specific orientation in the training data.

Alternatively, the generated output data of the convolution filter layer are combined over the plurality of parameter values in such a way that equivariance is established. For this, in the case of maximization over parameters (e.g., max pooling), for example, it is not (only) the output data for which the maximum is assumed, but rather the parameter value for which the maximum is assumed, that is outputted to a further processing instance, e.g., to a further neural network or a further layer. The further processing instance can then take that parameter value into consideration in the context of further processing. For example, the further processing instance could take into consideration the fact that a specific object is rotated or scaled, and take that into consideration in the context of classification.

According to an example embodiment of the present invention, the transformation is a controllable transformation in the sense that the convolution filter can be transformed, for example by way of a control equation, depending on the value of the parameter. The parameter can be, for example, an angle or a scaling parameter. In particular, a scaling parameter can be used in the convolution layer to scale the convolution filter, and the outputs of the convolution layer can be combined over various scaling parameter values. Combining (pooling) over scaling parameter values makes the layer of the convolutional network scaling-invariant. Analogously, combining (pooling) over angles makes the layer of the convolutional network angle-invariant.

The procedure of FIG. 7 makes it possible to decrease the number of parameters of the convolutional network. For example, utilization of a plurality of possible parameter values (e.g., a plurality of scaling values, e.g., all scaling values from a predefined region) improves robustness, and decreases the number of parameters of the convolutional network (e.g., as compared with the use of convolution filters of different scaling without subsequent pooling).

According to an example embodiment of the present invention, the transformation is learned from the training data upon training of the convolutional network. For example, a group of transformations from the training data, under which the training data are invariant, is learned.

The convolutional network can be used to process any type of sensor data, e.g. video data, radar data, lidar (light detection and ranging) data, ultrasonic data, motion data, etc. The output of the convolutional network can be control data (or at least the basis for control data that are generated by a downline-processing system), e.g., for a computer-controlled machine such as a robot, a vehicle, a household appliance, a power tool, a machine for producing a product, a personal assistant, or an access control system, or also an information transfer system such as a monitoring system or a medical (imaging) system.

According to an embodiment, the convolutional network is trained for such an application. The convolutional network can also be used to generate training data for training a second neural network.

Combining the output data of the convolution filter layer generated by applying the convolution filter over the plurality of parameter values encompasses, for example, ascertaining a parameter value for which a dimension of the output data of the filter is maximized. For application of the filter to a position of the input data, this is, for instance, the ascertainment of a parameter value for which an output value of the filter is maximal (i.e., max pooling). In the example of FIG. 4 and an angle, i.e., for instance the rotation angle of filter matrix 405 for which output value 404 becomes maximal. These maximal output data (e.g., this maximal output value) are then, for example, outputted (e.g., for each position of the input data to which the filter is applied when the filter is shifted over the input data). Other types of aggregation are also possible, such as averaging the output values of the filter over the parameter values (e.g., over the angles), etc. This can be respectively carried out independently for each position of the input data of the layer to which the filter is applied, or also collectively (for instance, the parameter value is ascertained and the pertinent output data, for which the average output value over several or all positions of the input data to which the filter is applied is maximal, is outputted).

According to an exemplifying embodiment of the present invention, the output data selected by the maximization are not themselves further processed (i.e., the maxima are not further processed), but instead only the parameter value ascertained by maximization of the output values is outputted in order to control a further convolution layer. This is nevertheless understood as an aggregation of the output data over the parameter values. The output data and the ascertained parameter value can also be outputted. Because the parameter value was ascertained by comparing the output data, this is nevertheless regarded as a combination of the output data (since they are clearly combined in the parameter value for which the maximum is assumed, or are combined by comparison thereof in order to ascertain the parameter value).

The method can be implemented by way of one or several circuits. In an embodiment, a “circuit” can be understood as any type of logic-implementing entity, which can be hardware, software, firmware, or a combination thereof. In an embodiment, a “circuit” can therefore be a hard-wired logic circuit or a programmable logic circuit, for example a programmable processor, for instance a microprocessor. A “circuit” can also be software that is implemented or executed by a processor, for instance any type of computer program. In accordance with an alternative embodiment, any other type of implementation of the respective functions that are described below in further detail can be understood as a “circuit.”

A “robot” can be understood as any physical system (having a mechanical part whose motion is controlled), such as a computer-controlled machine, a vehicle, a household appliance, a power tool, a production machine, a personal assistant, or an access control system.

The convolutional network can be used for regression or classification of data. The term “classification” also includes a semantic segmentation, e.g., of an image (which can be regarded as pixel-wise classification). The term “classification” also includes detection, for instance of an object (which can be regarded as a classification as to whether or not the object is present).

Although the present invention has been shown and described principally with reference to specific embodiments, it should be understood by those familiar with the technical sector that numerous modifications can be made thereto, in terms of configuration and details, without deviating from the essence and field of the present invention as described herein.

What is claimed is:

1. A computer-implemented method for processing sensor data using a convolutional network, comprising:
processing the sensor data using several successive layers of the convolutional network, the convolutional network having:
a convolution filter layer that:
receives at least one input matrix having input data values;
implements a first filter matrix that is defined by a sum, weighted with a first weighting, of basic filter functions;
calculates at least a second weighting from the first weighting by applying to the first weighting, for a respective value of a transformation parameter, a transformation formula that is parameterized by the transformation parameter;
for each second weighting, ascertains a respective second filter matrix by calculating a sum, weighted with the second weighting, of the basic filter functions; and
convolutes the input matrix with the first filter matrix and with each of the second filter matrices, so that for each filter matrix, an output matrix having output data values is generated; and
an aggregation layer that combines the output matrices.

2. The method as recited in claim 1, wherein the transformation parameter is an angle, and the convolution filter layer calculates the second weighting by applying the transformation formula in such a way that the second filter matrix is the first filter matrix rotated through the angle.

3. The method as recited in claim 1, the transformation parameter being a scaling parameter, and the convolution filter layer calculating the second weighting by applying the transformation formula in such a way that the second filter matrix is a scaling of the first filter matrix, the intensity of the scaling being defined by the scaling parameter.

4. The method as recited in claim 1, wherein the aggregation layer ascertains, for each of the output matrices, a respective value of a predefined evaluation variable, and combines the output matrices by outputting identification of one of the output matrices for which the evaluation variable is maximal.

5. The method as recited in claim 1, further comprising:
training of the convolutional network by comparing values predicted for training data by the convolution network with reference values predefined for the training data, wherein coefficients of the first weighting and/or coefficients of the transformation formula are trained.

6. The method as recited in claim 1, further comprising:
controlling an actuator based on an output of the convolutional network.

7. A convolutional network configured to process sensor data, the convolutional network being configured to:
process the sensor data using several successive layers of the convolutional network, the convolutional network having:
a convolution filter layer that:
receives at least one input matrix having input data values;
implements a first filter matrix that is defined by a sum, weighted with a first weighting, of basic filter functions;
calculates at least a second weighting from the first weighting by applying to the first weighting, for a respective value of a transformation parameter, a transformation formula that is parameterized by the transformation parameter;
for each second weighting, ascertains a respective second filter matrix by calculating a sum, weighted with the second weighting, of the basic filter functions; and
convolutes the input matrix with the first filter matrix and with each of the second filter matrices, so that for each filter matrix, an output matrix having output data values is generated; and
an aggregation layer that combines the output matrices.

8. A hardware agent, comprising:
a sensor that is configured to furnish sensor data; and
a convolutional network configured to process sensor data, the convolutional network being configured to:
process the sensor data using several successive layers of the convolutional network, the convolutional network having:
a convolution filter layer that:
receives at least one input matrix having input data values;
implements a first filter matrix that is defined by a sum, weighted with a first weighting, of basic filter functions;
calculates at least a second weighting from the first weighting by applying to the first weighting, for a respective value of a transformation parameter, a transformation formula that is parameterized by the transformation parameter;
for each second weighting, ascertains a respective second filter matrix by calculating a sum, weighted with the second weighting, of the basic filter functions; and
convolutes the input matrix with the first filter matrix and with each of the second filter matrices, so that for each filter matrix, an output matrix having output data values is generated; and
an aggregation layer that combines the output matrices.

9. The hardware agent as recited in claim 8, wherein the hardware agent is a robot.

10. The hardware agent as recited in claim 8, further comprising:
at least one actuator; and
a control device that is configured to control the at least one actuator using an output of the convolutional network.

11. A non-transitory machine-readable storage medium on which is stored program instructions for processing sensor data using a convolutional network, the program instruction, when executed by one or more processors, causing the one or more processors to perform:
processing the sensor data using several successive layers of the convolutional network, the convolutional network having:
a convolution filter layer that:
receives at least one input matrix having input data values;
implements a first filter matrix that is defined by a sum, weighted with a first weighting, of basic filter functions;
calculates at least a second weighting from the first weighting by applying to the first weighting, for a respective value of a transformation parameter, a transformation formula that is parameterized by the transformation parameter;
for each second weighting, ascertains a respective second filter matrix by calculating a sum, weighted with the second weighting, of the basic filter functions; and
convolutes the input matrix with the first filter matrix and with each of the second filter matrices, so that for each filter matrix, an output matrix having output data values is generated; and
an aggregation layer that combines the output matrices.
